(19) United States
(12) Patent Application Publication
(10) Pub. No.: US 2004/0064622 A1
(43) Pub. Date: Apr. 1, 2004

(54) Signal processing resource with sample-by-sample selective characteristics

(76) Inventor: Winthrop W. Smith, Richardson, TX (US)

Correspondence Address: ROBERT H FRANTZ, P O BOX 23324, OKLAHOMA CITY, OK, 73123

(21) Appl. No.: 10/260,749

(22) Filed: Sep. 30, 2002

(51) Int. Cl. G06F 13/14

(52) U.S. Cl. 710/305

(57) ABSTRACT

A signal processing resource system with multiple sets of coefficients, channel context memories, and configuration control logic sets organized into signal processing personalities which are multiplexed in their use according to input data organization. Adaptable signal processing characteristics, processing suspension, processing resumption and seeding of signal processing context is provided. Control logic allows a data stream to be processed using multiple signal processing characteristics or “personalities” according to associations or groupings of coefficient, channel context, and control logic sets.

### CROSS-REFERENCE TO RELATED APPLICATIONS (CLAIMING BENEFIT UNDER 35 U.S.C. 120)

This application is related to U.S. patent application Ser. No. 09/850,939, filed on May 8, 2001, docket number TFT2001-001, by Winthrop W. Smith. This application is also related to U.S. patent application Ser. No. 10/198,021, filed on Jul. 18, 2002, docket number TFT2002-002, also by Winthrop W. Smith.

### TECHNICAL FIELD OF THE INVENTION

This invention relates to, but is not limited to, the fields of embedded signal processing resources.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

The related U.S. patent applications, Ser. Nos. 09/850,939 and 10/198,021, filed on May 8, 2001, and on Jul. 18, 2002, docket numbers TFT2001-001 and TFT2002-002, respectively, both by Winthrop W. Smith, are hereby incorporated by reference in their entireties, including drawings.

### BACKGROUND OF THE DISCLOSURE

There are many applications of image and signal processing which require more microprocessing bandwidth than is available in a single processor at any given time. As microprocessors are improved and their operating speeds increase, so too are the application demands continuing to meet or exceed the ability of a single processor. For example, there are certain size, weight and power requirements to be met by processor modules or cards which are deployed in military, medical and commercial end-use applications, such as a line replaceable unit (“LRU”) for use in a signal processing system onboard a military aircraft. These requirements typically limit a module or card to a maximum number of microprocessors and support circuits which may be incorporated onto the module due to the power consumption and physical packaging dimensions of the available microprocessors and their support circuits (memories, power regulators, bus interfaces, etc.).

As such, a given module design or configuration with a given number of processors operating at a certain execution speed will determine the total bandwidth and processing capability of the module for parallel and distributed processing applications such as image or signal processing. Thus, as a matter of practicality, it is determined whether a particular application can be ported to a specific module based upon these parameters. Any applications which cannot be successfully be ported to the module, usually due to requiring a higher processing bandwidth level than available on the module, are implemented elsewhere such as on mini-super computers.

As processor execution rates are increased, microprocessing system component integration is improved, and memory densities are improved, each successive multi-processor module is redesigned to incorporate a similar number of improved processors and support circuits. So, for example, a doubling of a processor speed may lead to the doubling of the processing bandwidth available on a particular module. This typically allows twice as many “copies” or instances of applications to be run on the new module than were previously executable by the older, lower bandwidth module. Further, the increase in processing bandwidth may allow a single module to run applications which were previously too demanding to be handled by a single, lower bandwidth module.

The architectural challenges of maximizing processor utilization, communication and organization on a multi-processor module remains constant, even though processor and their associated circuits and devices tend to increase in capability dramatically from year to year.

For many years, this led the military to design specialized multi-processor modules which were optimized for a particular application or class of applications, such as radar signal processing, infrared sensor image processing, or communications signal decoding. A module designed for one class of applications, such as a radar signal processing module, may not be suitable for use in another application, such as signal decoding, due to architecture optimizations for the one application which are detrimental to other applications.

In recent years, the military has adopted an approach of specifying and purchasing computing modules and platforms which are more general purpose in nature and useful for a wider array of applications in order to reduce the number of unique units being purchased. Under this approach, known as “Commercial-Off-The-Shelf” (“COTS”), the military may specify certain software applications to be developed or ported to these common module designs, thereby reducing their lifecycle costs of ownership of the module.

This has given rise to a new market within the military hardware suppliers industry, causing competition to develop and offer improved generalized multi-processor architectures which are capable of hosting a wide range of software applications. In order to develop an effective general hardware architecture for a multi-processor board for multiple applications, one first examines the common needs or nature of the array of applications. Most of these types of applications work on two-dimensional data. For example, in one application, the source data may represent a 2-D radar image, and in another application, it may represent 2-D magnetic resonance imaging. Thus, it is common to break the data set into portions for processing by each microprocessor. Take an image which is represented by an array of data consisting of 128 rows and 128 columns of samples. When a feature recognition application is ported to a quad processor module, each processor may be first assigned to process 32 rows of data, and then to process 32 columns of data. In signal processing parlance this is known as “corner turning”. Corner turning is a characteristic of many algorithms and applications, and therefore is a common issue to be addressed in the interprocessor communications and memory arrangements for multi-processor boards and modules.

One microprocessor which has found widespread acceptance in the COTS market is the Motorola PowerPC [™]. Available modules may contain one, two, or even four PowerPC processors and support circuits. The four-processor modules, or “quad PowerPC” modules, are of particular interest to many military clients as they represent a maximum processing bandwidth capability in a single module.

Quad Power PC board or module architectures on the market generally include “shared memory”, “distributed memory architecture” and “dual memory” architectures. These architectures, though, could be employed well with other types and models of processors, inheriting the strengths and weaknesses of each architecture somewhat independently of the processor chosen for the module.

One advantage of distributed memory architecture modules is that input data received at a central crossbar can be “farmed out” via local crossbars to multiple processors nodes that perform the processing of the data in parallel and simultaneously. Quad PowerPC cards such as this are offered by companies such as CSP Inc., Mercury Computer Systems Inc., and Sky Computers Inc.

For example, during the first phase of processing a hypothetical two-dimensional (2-D) data set of 128 rows by 128 columns shown in TABLE 1 on a distributed memory quad processor card, a first set of 32 rows (rows 0-31) of data may be sent to a first processor node, a second set of 32 rows (rows 32-63) of data would be sent to a second processor node, a third set of 32 rows (rows 64 to 95) of data to the third processor node, and the fourth set of 32 rows (rows 96 to 127) of data to the fourth processor node. Then, in preparation for a second phase of processing data by columns, a corner turning operation is performed in which the first processor node would receive data for the first 32 columns, the second processor node would receive the data for the second 32 columns, and so forth.

TABLE 1
Example 128 × 128 Data Array

| | Column | | | | | | | |
|---|---|---|---|---|---|---|---|---|
| Row | 0 | 1 | 2 | 3 | 4 | . . . | 126 | 127 |
| 0 | 0xFE | 0x19 | 0x46 | 0x72 | 0x7A | . . . | 0x9C | 0x4B |
| 1 | 0x91 | 0x22 | 0x4A | 0xA4 | 0xF2 | . . . | 0xBE | 0xB3 |
| 2 | 0x9A | Ox9C | 0x9A | 0x98 | 0x97 | . . . | 0x43 | 0x44 |
| 4 | 0x00 | 0x00 | 0x81 | 0x8F | 0x8F | . . . | 0x23 | 0x44 |
| . | . | . | . | . | . | . . . | . | . |
| . | . | . | . | . | . | | . | . |
| . | . | . | . | . | . | . . . | . | . |
| . | . | . | . | . | . | | . | . |
| 126 | 0x34 | 0x3A | 0x36 | 0x35 | 0x45 | . . . | 0xFB | 0xFA |
| 127 | 0x75 | 0x87 | 0x99 | 0xF0 | 0xFE | . . . | 0xFF | 0xFA |

Regardless of the type of bus used to interconnect the processor nodes, high speed parallel or serial, this architecture requires movement of significant data during a corner turning operation during which data that was initially needed for row processing by one processor node is transferred to another processor node for column processing. As such, the distributed memory architecture has a disadvantage with respect to efficiency of performing corner turning. Corner turning on multi-processor modules of this architecture type consumes processing bandwidth to move the data from one processor node to another, bandwidth which cannot be used for other computations such as processing the data to extract features or performing filtering algorithms.

Turning to the second architecture type commonly available in the COTS market, the advantage of shared memory architectures is that all data resides in one central memory. COTS modules having architectures such as this are commonly available from Thales Computers Corp., DNA Computing Solutions Inc., and Synergy Microsystems. In these types of systems, several processor nodes may operate on data stored in a global memory, such as via bridges between processor-specific buses to a standard bus (PowerPC bus to Peripheral Component Interconnect “PCI” bus in this example).

The bridges are responsible for arbitrating simultaneous attempts to access the global memory from the processor nodes. Additionally, common modules available today may provide expansion slots or daughterboard connectors such as PCI Mezzanine Connector (PMC) sites, which may also provide data access to the global memory. This architecture allows for “equal access” to the global data store, including the processor(s) which may be present on the expansion sites, and thus eases the decisions made during porting of large applications to specific processor nodes because each “job” to be ported runs equally well on any of the processor nodes.

Due to the centralized memory in this architecture, corner turning can be performed by addressing the shared memory with a pointer that increments by one when processing row data, and increments by the number of data samples in a row when processing column data. This avoids the need to ship or move data from one processor node to another following initial row-data processing, and thereby eliminates wasted processor cycles moving that data.

However, in this particular arrangement, all processors must access data from the same shared memory, which often leads to a “memory bottleneck” that slows execution times due to some processor node requests being arbitrated, e.g. forced to wait, while another processor accesses the global memory. Thus, what was gained in eliminating the wasted processor cycles for moving data from node to node may be lost to wait states or polling loops caused by arbitration logic for accesses to shared memory.

Another multiprocessor architecture commonly found in modules available on the COTS market is the dual memory architecture, which is designed to utilize the best features of distributed and shared memory architectures, to facilitate fast processing and reduce corner turning overhead. Both memory schemes are adopted, providing the module with a global memory accessible by all processor nodes, and local memory for each processor or subset of processor nodes. This addresses the arbitration losses in accessing a single shared global memory by allowing processor node to move or copy data which is needed for intense accesses from global memory to local memory. Some data which is not so intensely needed by a processor is left in the global memory, which reduces the overhead costs associated with corner turning. DY-4 Systems offers a module having an architecture such as this. An issue with this type of architecture remains with data reorganization performance, as with the distributed architecture. While it provides only two memories and therefore can perform some steps of corner-turning like a shared memory architecture, it eventually must pass data across the interface between the two memory banks to finish the corner-turning process. When it does that, there is only one data path, unlike the two data paths available in the distributed memory architecture. So, while the needed data passing is a smaller amount, it is typically slower than the distributed memory architecture, thus, oftentimes, there is no net gain in performance.

Most modern processors have increased their internal clock rate and computational capabilities per clock (or per cycle) faster than their ability to accept the data they need to process. In other words, most modern processors can now process data faster than they can read or write the data to be processed due to I/O speed limitations on busses and memory devices.

As a result, “operations/second” is no longer the chief concern when determining whether a particular processor or processor node is capable of executing a particular application. This concern has been replaced by data movement bandwidth as the driving consideration in measuring the performance of single processors, processor nodes and arrays of processors.

Each of the previously discussed architectures has strong points and weak points. For example, some architectures have nearly twice the performance for processor to local memory data movement than for node to node or module I/O data movement. For applications which utilize local memory heavily and do not need intense node-to-node movement or board I/O data flow, these may be adequate. But, this imbalance among data movement paths can eliminate these two boards from candidacy for many applications. On the contrary, other boards have a good balance between the data movement paths, but at the cost of efficient local memory accesses.

The related patent applications establish that our new multiprocessor architecture for distributed and parallel processing of data which provides optimal data transfer performance between processors and their local memories, from processor to processor, and from processors to module inputs and outputs, satisfies many needs in the art. Our new arrangement or architecture provides maximum performance when accessing local memory as well as nominal performance across other data transfer paths. Further, the related applications establish that our architecture is useful for realization with any high speed microprocessor family or combination of microprocessor models, including those microprocessors which are commonly used for control or signal processing applications and which exhibit I/O data transfer constraints relative to processing bandwidth. Our systems and methods described in the related patent applications addressed these needs, and are summarized in the following paragraphs.

Our systems and methods disclosed in the related patent applications utilize a programmable logic array in a position between each microprocessor node and its memory, and provided functionality to allow each microprocessor in the multiprocessor array to access memory associated with another microprocessor in the array.

In order to maximize the capabilities of our system, it was desirable to extend the functionality of the multiprocessor array to utilize the programmable logic arrays to actually perform some level of processing, and especially signal processing, on the data stored in the processor memories and the data which flows through the logic array.

Programmable logic device suppliers such as Xilinx have promoted use of their devices to perform signal processing functions in hardware rather than using the traditional software or microprocessor-based firmware solutions. Thus, the combination of the location of the programmable logic in the topology of our system disclosed in the related patent applications and the availability of signal processing “macros” and designs for programmable logic produced an opportunity to embed signal processing in the new multiprocessor topology, thereby increasing the density of functionality and capability of the new architecture.

Additionally, we have also added a capability to our systems, methods, and architectures which allow these embedded signal processing functions to provide a selectable set of processing characteristics which are activated on a sample-by-sample basis, thereby enabling a multiplexed use of the “hardware” or internal FGPA resources over time.

### SUMMARY OF THE DISCLOSURE

A system and method for providing sample-by-sample selectable characteristics of embedded signal processing resources useful in cooperation with a processor system such as, for example, a quad-processor arrangement having six interprocessor communications paths, one direct communication path between each of the two possible pairs of processors, with signal processing functions embedded in the communications paths as disclosed in the related patent applications.

### BRIEF DESCRIPTION OF THE DRAWINGS

FIG. 1 illustrates the top-level view of our arrangement and architecture of the multiprocessor module.

FIG. 2 provides additional detail of an internal architecture of the field programmable gate array for a processing node of the architecture as shown in FIG. 1.

FIG. 3 shows a signal processing framework contained within the field programmable gate array of FIG. 2.

FIG. 4 illustrates an example building block for a finite impulse response (“FIR”) filter.

FIG. 5 illustrates some general configuration possibilities for such FIR filters.

FIG. 6 provides an example of a digital receiver configuration using our system.

FIG. 7 provides details of a well known benchmark process used in the COTS industry to measure and gage the performance of processors and multiple processor complexes.

FIG. 8 discloses a graphical comparison between functions implemented on a multiprocessor module according to the related patent application compared to the density achieved when the present invention is realized with the multiprocessor module architecture.

FIG. 9 provides an illustration of an FIR filter block which implements multiple “personalities” using multiple selectable coefficient sets, channel memories, and optionally multiple control logic sets and/or adaption logic sets.

FIG. 10 depicts one possible personality multiplexing scheme in which a data stream of multiplexed data channels is processed by a set of 4 personalities.

FIG. 11 depicts an alternate personality multiplexing scheme including a down sampling operation and parallel signal processing functions.

FIG. 12 illustrate another alternate personality multiplexing scheme with series processing functions, parallel processing functions, and data broadcasting capabilities.

FIG. 13 provides details of an enhanced embodiment of the parameter port which allows “seeding” of processing function values (e.g. loading coefficients and channel memory), and saving of processing function contexts (e.g. reading out coefficient and channel memory contents).

### DETAILED DESCRIPTION OF EMBODIMENTS OF THE INVENTION

In one possible embodiment, our architecture is realized using four Motorola PowerPC [™] G4 processors in the data transfer path topology as disclosed in the related patent application. However, it will be recognized by those skilled in the art that the architecture and arrangement of our system may be realized using a variety of high speed microprocessor families or combinations of microprocessor models, including but not limited to those which are commonly used for control or signal processing applications and those which exhibit I/O data transfer constraints relative to processing bandwidth.

The field programmable logic of one possible embodiment which is responsible for data path functions is extended to include a signal processing framework within the data path. As such, this programmable logic can be configured and used as a signal processing resource in conjunction or cooperation with the software capabilities of the microprocessors.

Therefore, the remainder of this disclosure is given in terms of implementation with the PowerPC [™] microprocessor and the architecture of this example embodiment with the stipulation that the methods and data transfer paths disclosed herein may be equally well adopted between an arrangement of any set of processors in alternate embodiments.

Basic Communication Paths

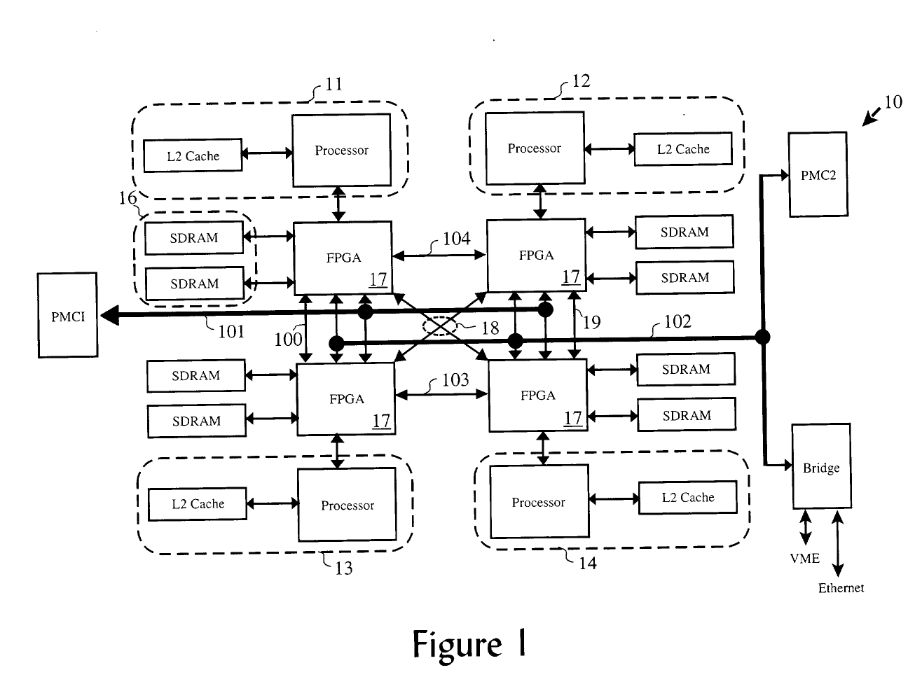

Turning to FIG. 1, the module architecture according to the preferred embodiment provides four processor nodes (11, 12, 13, 14), each node containing a member of the Motorola PowerPC [™] family microprocessors and associated support circuitry. Each of the processors is interfaced to an external level 2 (L2) cache memory, as well as a programmed field programmable gate array (FPGA) device (17).

The nodes (11, 12, 13, and 14) are interconnected to the programmed FPGA devices (17) such that interprocessor data transfer paths are established as follows:

(a) a“neighbor” path (104) between the first node (11) to the second node (12);

(b) a “neighbor” path (19) between the second node (12) to the fourth node (14);

(c) a “neighbor” path (103) between the fourth node (14) to the third node (13)

(d) a “neighbor” path (100) between the third node (13) to the first node (11);

(e) a “diagonal” path (18) between the first node (11) and the fourth node (14); and

(f) a “diagonal” path (18) between the second node (12) and the third node (13).

In this new arrangement, every processor node is provided with a direct communication path to the other three processor nodes' local memory. According to the preferred embodiment, these paths are each 32-bit parallel bus, write-only paths. By defining the paths as write-only, arbitration circuitry and logic in the FGPA's is simplified and more efficient.

Software processes which require data from the memory of another processor node may “post” or write a request into the memory of the other processor, where a task may be waiting in the other processor to explicitly move the data for the requesting task. Alternate embodiments may allow each path to be read-only, or read-write, as well as having alternate data widths (e.g. 8, 16, 64, 128-bits, etc.).

The six interprocessor communication paths allow each processor in each node to have access to its own local memory. In a related embodiment, each processor may also have “mapped into” its local memory space a portion of local memory of each of the other processors, as well. This allows the tasks in each processor to move only the data that needs to be moved, such as during corner turning, and to access data needed for processing from a local memory without arbitration for accesses to a global shared memory.

Also according to this exemplary embodiment, board I/O communication paths (101 and 102) are provided between the FPGAs (17) and board I/O connectors, such as a VME bus connector, PMC expansion sites, and or an Ethernet daughterboard connector.

Configurability of Interprocessor Communication Path Interconnects

As the interprocessor or node-to-node communications path interconnects are implemented by buffering and control logic contained in the FGPA programs, and as the this particular embodiment utilizes a “hot programmable” FPGA such as the Xilinx XCV 1600-8-FG 1156 [™], the quad processor module can be reconfigured at two critical times:

(a) upon initialization and loading of the software into the processor nodes, such that the paths can be made, broken, and optimized for an initial task organization among the processors; and

(b) during runtime on a real-time basis, such that paths may be dynamically created, broken or optimized to meet temporary demands of the processor module tasks and application.

This allows the module and architecture to be configured to “look like” any of the well-known architectures from the viewpoint of the software with respect to data flow topologies.

Local Memory Configuration

Each processor node (11, 12, 13, 14) is configured to have dual independent local memory banks (16), preferably comprised of 32 MB SDRAM each. A processor can access one of these banks at a given time, while the other bank is accessed by the module I/O paths (101) and (102). This allows another board or system to be loading the next set of data, perhaps from the board I/O bus, while each on-board processor works on the previous set of data, where the next set of data is stored in one bank and the previous set of data is stored in another bank. This eliminates arbitration and contention for accessing the same memory devices, thereby allowing the processor to access the assigned local memory bank with maximized efficiency. Alternate embodiments may include different depths, widths, or sizes of memory, and/or different memory types (e.g. FlashROM, ROM, DRAM, SRAM, etc.), of course.

Further according to this exemplary embodiment, the programmed FPGAs (17) provide DMA engines that can automatically move data to and from the processors (11), using the board I/O communication paths (101, 102) and the interprocessor communications paths, without processor intervention. This allows processing and data movement to be performed in parallel, autonomously and simultaneously, without having to contend for access to each other's memories as in the shared memory and multi-port memory arrangements known in the art. Alternate embodiments of the function of the FPGA's may not include such DMA capabilities, and may be implemented in alternate forms such as processor firmware, application specific integrated circuits (ASICs), or other suitable logic.

Further according to this exemplary embodiment, addressing for the two memory banks is defined such that the four “upper” memory banks, one for each processor, form one contiguous memory space, while the four “lower” memory banks, again one for each processor, form a second contiguous but independent memory space. This addressing scheme may be omitted in some alternate embodiments, but when utilized, it provides for a further increase in the efficiency with which software processes may access the local and remote memories. Alternate embodiments can be realized which include usage of more than two memory banks per processor, organizing one or more banks of memory into“pages”, etc.

Interprocessor Communications Path Interconnections and Configurations

The communication paths between the processor nodes are defined by the programmed FPGA devices (17) in this exemplary embodiment. Each FPGA device provides full 64-bit data and 32-bit address connections to the two memory banks local to it, in the preferred embodiment. The three paths from local processor to non-local memory (e.g. other processor nodes' local memories) are also 32-bits wide, and are write only, optimized for addressing the corner-turn processing function in two-dimensional signal processing. Alternate embodiments, of course, may use other types of logic such as ASICs or co-processors, and may employ various data and address bus widths.

Module I/O

In the preferred embodiment, the module provides two 64-bit, 66 MHz PCI-based board I/O communications interfaces (101 and 102), interfaced to the following items:

(a) a first PCI bus (101) to PMC1 site, Race ++ or P0 to all processor nodes; and

(b) a second PCI bus (102) to PMC2 site to all processor nodes, preferably with a bridge to other bus types including VME and Ethernet.

As previously discussed regarding this exemplary embodiment, the programmed FPGAs provide DMA engines for moving data in and out of the various local memories via the six communications paths (100, 18, 19, 103, 104) and the board I/O busses. In alternate embodiments, direct reading and writing of data in the local memory by the processors may also be allowed. Alternate module I/O interfaces may be incorporated into the invention, including, but not limited to, alternate bus interfaces, expansion slot or connector interfaces, serial communications, etc.

Enhanced Module Functional Features

The multiple parallel interconnections between processor nodes allow the module to be configured to emulate various functions inherently advantageous to real-time processing, including:

(a) Ping-Pong Memory Processing, which is a technique commonly used for real-time applications to allow simultaneous, independent processing operations and data I/O operations.

(b) “Free” corner turning, which is required by nearly all applications that start with a 2-D array of data. Typically, the processing of that 2-D array of data starts with processing along the rows of the array, followed by processing down the columns of the data array. To make efficient use of the power of the processors, the data to be first processed in the row dimension should all be located in the local memory of the processor(s) executing that work. Similarly, to make efficient use of the processors, the data to be subsequently processed in the column dimension should all be located in the local memory of the processor(s) performing subsequent or second phase of processing. In general, these are different sets of data and different processors. Therefore, rearranging the data (e.g. corner turning) must occur between the two phases of processing. In one embodiment of our new architecture, memory-to-memory movement is automatically provided. In another embodiment, output data from the first stage of processing may be automatically moved to the local memory of a second processor, where it is needed for the second phase of processing along columns. This technique avoids explicit movement of the data for corner turning entirely. Alternatively, by employing the FPGA DMA engines, this data or any other data in one processor's local memory can be moved to the local memory of another processor with no processor cycles wasted or used for the data movement. This latter approach may be useful in some applications where data is to be “broadcast” or copied to multiple destinations, as well. In either case, the data movement operation is a “free” operation on the module.

(c) Multiple Architecture Configurations. There are two reasons it is useful to be able to configure the module's data paths to be organized like its lower performance counterparts. First, this allows applications to be easily moved from that counterpart board to the module first when configured similar to the counterpart. Later, the application software can be optimized for the higher performance capabilities of the module as a second, lower risk step. The second reason is that certain portions of an application may work better in one architecture than another. Dynamic reconfigurability of the module allows the application software to take advantage of that peculiarity of portions of the application to further optimize performance. As such, the module can be statically or dynamically configured through FPGA programs to resemble and perform like a pure distributed architecture, pure shared memory architecture, or hybrids of shared and distributed.

Signal Processing Functions Configurably Embedded Communications Paths

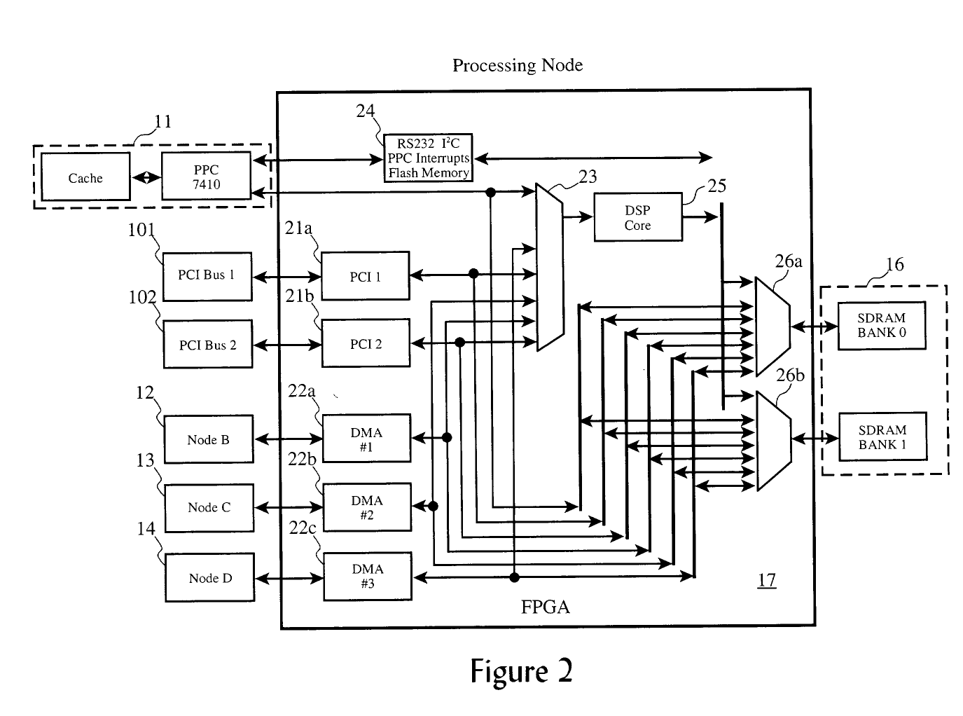

In this exemplary embodiment, the FPGA (17) is configured to include the signal processing node (25) as shown in FIG. 2. The FPGA (17) is configured to have one or two PCI bus interfaces (21a, 21b), a direct memory access (“DMA”) interface (22a, 22b, 22c) to each of the other processing nodes of the module, as well as internal bus selectors (26a, 26b) to the memory banks (16).

The DSP node (25) may receive data selectively (23) from either PCI interface (21a, 21b) from the PCI buses (101, 102) of the module, from the local processor (11), from any other processor node via DMA (22a, 22b, 22c), or from either of the local memories (16), as determined by DSP node data input selector (23).

In this arrangement, data may be received by the DSP node (25) from any of the other processor nodes, from local memory, or from source outside the quad processor arrangement (e.g. off-board sources), such that the data may be processed prior to storage and either of the memory banks (16).

With this addition of functionality to the FPGAs, our Matched Heterogeneous Array Topology Signal Processing System (“MHAT”) is realized. One or more signal processing functions may be loaded into the DSP node (25) so as to allow data to be processed prior to storing in the memory banks (16). MHAT provides a marriage of the microprocessors and the FPGAs to facilitate simultaneous data processing and data reorganization, which reduces real-time operating system interrupt overhead processing and complexity.

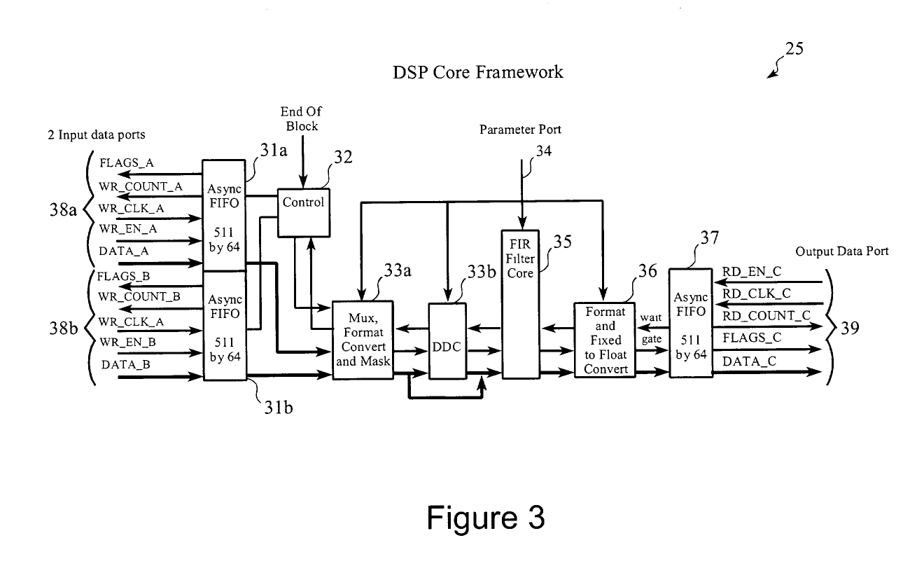

Turning to FIG. 3, the internal architecture of a DSP node (25) which provides a framework for hosting a variety of signal processing functions (35) is shown. The signal processing functions may include operations such as FIR filters, digital receivers, digital down converters, fast Fourier transforms (“FFT”), QR decomposition, time-delay beamforming, as well as other functions.

To input data ports (38a, 38b) are provided, each of which receive data into an asynchronous first-in first-out (“FIFO”) (31a, 31b). The data may then be multiplexed, formatted, and masked (33a), and optionally digitally down converted (33b) prior to being received into the signal processing logic (35).

After being processed by the signal processing logic (35), the data may again be formatted, converted from fixed point representation to floating point representation (36), and then it is loaded into an output asynchronous FIFO for eventual output to the output data port (39).

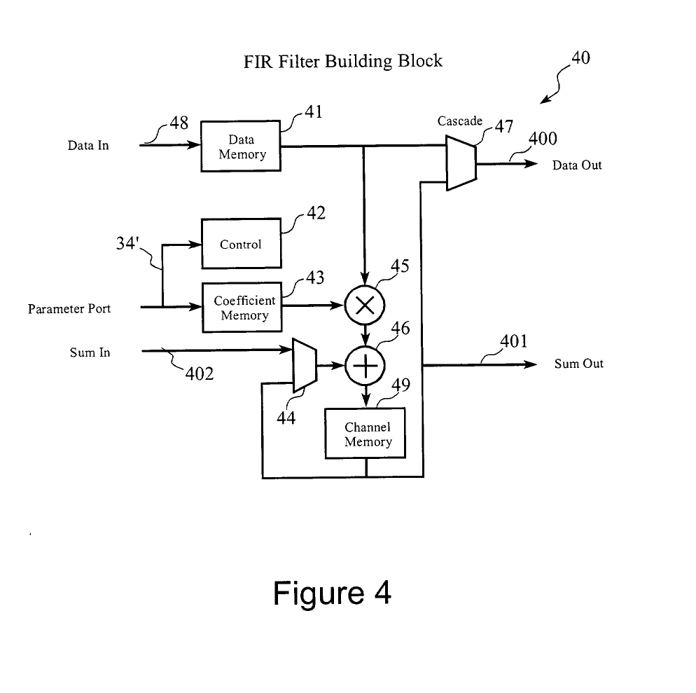

FIG. 4 provides more details of an FIR building block (40) which may be configured into the portion of the signal processing logic (35). Data which is received (48) from the previous building block or from the signal processing logic input formatters and digital down converters is received into the data memory (41). The data may then be multiplied (45) by coefficients stored in coefficient memory (43), summed (46) with previous summation results or (44) summation results from other building blocks (401, 402), the results of which operations is stored in channel memory (49).

The coefficient memory (43) may be loaded with coefficient values via the parameter port (34) to implement a filter having the desired properties. Control parameters (42) may also select (44) the source for summation (46) from channel memory (49) or a summation input (402). These coefficient values and input/output selections may be statically loaded for the duration of operation (e.g. their values are not changed during operation, so the function's characteristics remain the same through operation), or they may be selected and managed on a per-sample or other basis as described later in this disclosure.

Each summation result is presented at a summation output (401), as well selectively (47) at a block cascading data output (400) as determined by additional control parameters. Data which is received at the data input (48) can be selected (47) to flow through data memory (41) correctly to the data output (400), as well.

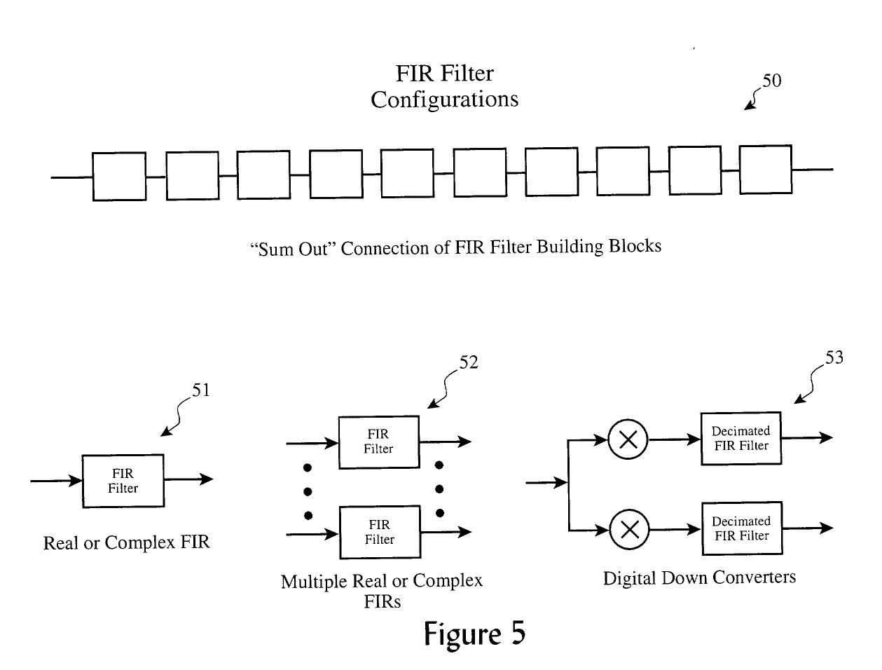

As such, multiple building blocks may be cascaded by interconnecting data inputs, data outputs, summation inputs, in summation outputs. Further, each building block may be customized and configured to have specific properties or characteristics as defined by the coefficients in control settings stored into the control memory (42) and coefficient memory (43), which is loadable by the microprocessor. In FIG. 5, a “sum out” connection arrangement (50) of such FIR filter building blocks is shown. This may include a single real or complex FIR filter (51), multiple filters (52), and digital down converters (53), as well as other functions. With this arrangement, a series of signal processing operations may be implemented which allows data to be processed in transit from one processing node's local memory to the local memory banks of another processor.

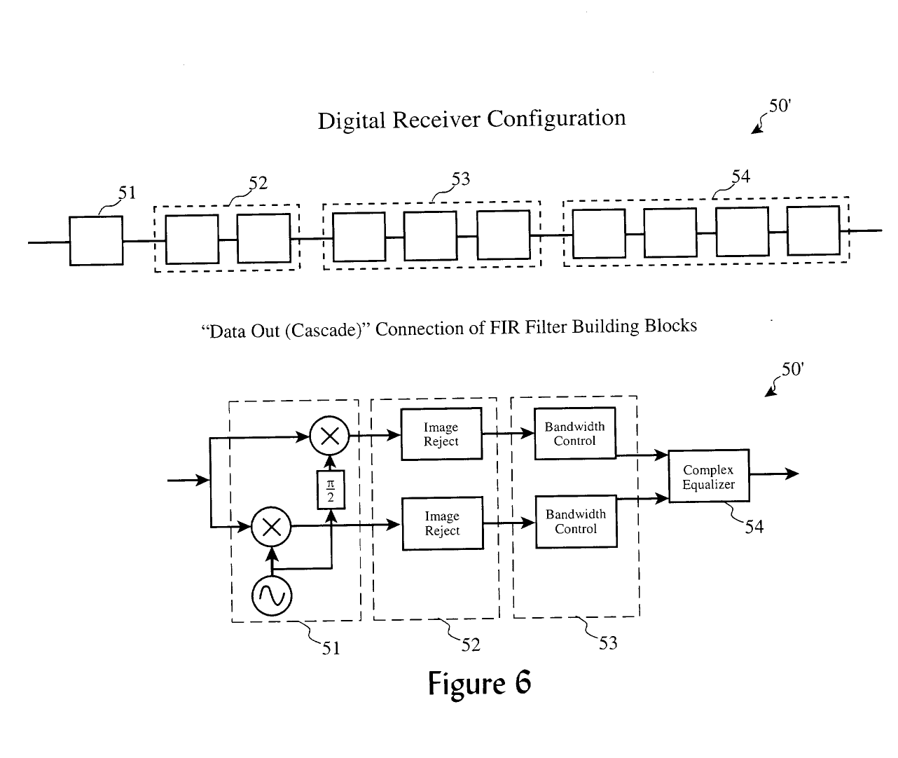

In FIG. 6, a “data out” or cascade connection arrangement (50′) of signal processing building blocks for a digital receiver is shown. In this example, a demodulator (51) is followed by image rejection (52) functions, which are in turn followed by bandwidth control functions (53), in which are followed by the complex equalizer (54). Similar to the discussion of FIG. 5, the embodiment or implementation of an FIR filter is not restricted to the particular disclosure here, nor is the type of signal processing function restricted only to these particular blocks. Further, the topology of interconnected signal processing functions may take a variety of forms, combining series and parallel interconnections as needed for specific applications.

Benchmark Performance Comparison

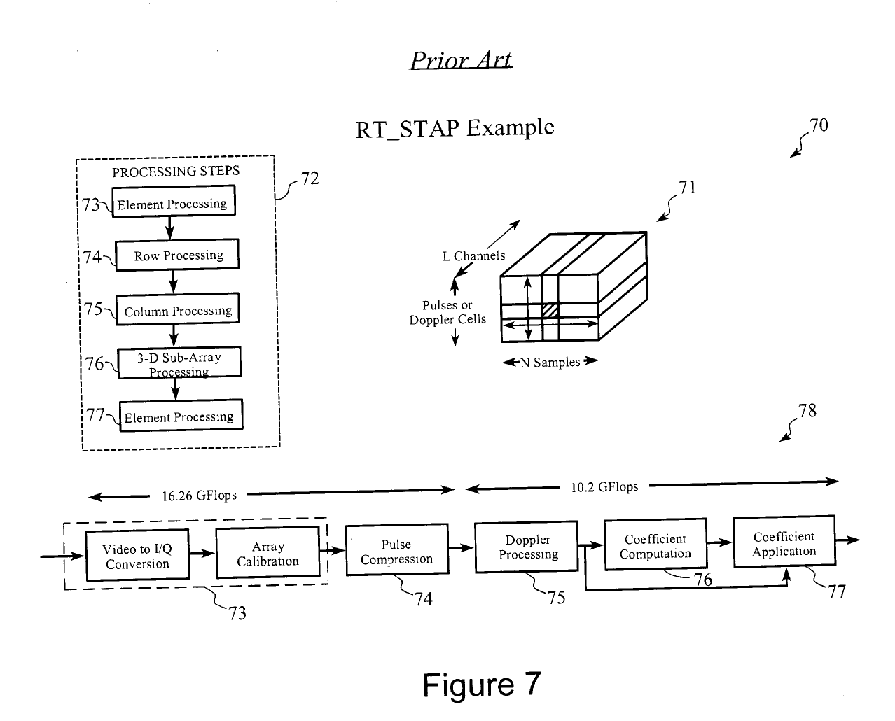

Turning to FIG. 7, the “RT_STAP” benchmark process used to measure the performance and functional density of COTS processing modules is shown. This particular process represents a task to find targets on a ground surface in a signal set acquired from an airborne platform such as an airplane. The benchmark process is designed to utilize various portions of processor modules (e.g. DMA, memory busses, interrupts, etc.), such that it represents a broad measurement of processing module's capabilities. It also includes a mix of types of processes, including simple sample-by-sample calculations in in-phase and quadrature (“I/Q) data (73), followed by pulse compression (74) correlation process, during which a corner turning process must be performed to transpose a matrix (71), followed by some Doppler processing (75), followed by a “QRD” function (76), which is an equations solver for performing adaptive processing. These processes are each well known in the art, and are commonly used within various mission profiles often performed by such multiprocessor modules.

As can be seen from this illustration, a particular implementation in software alone in an existing multiprocessor board may require 16.26 billion floating point operations per second (GigaFLOPS) to perform the initial processing (73, 74), and another 10.2 GigaFLOPS to perform the latter processing functions (75, 76, 77).

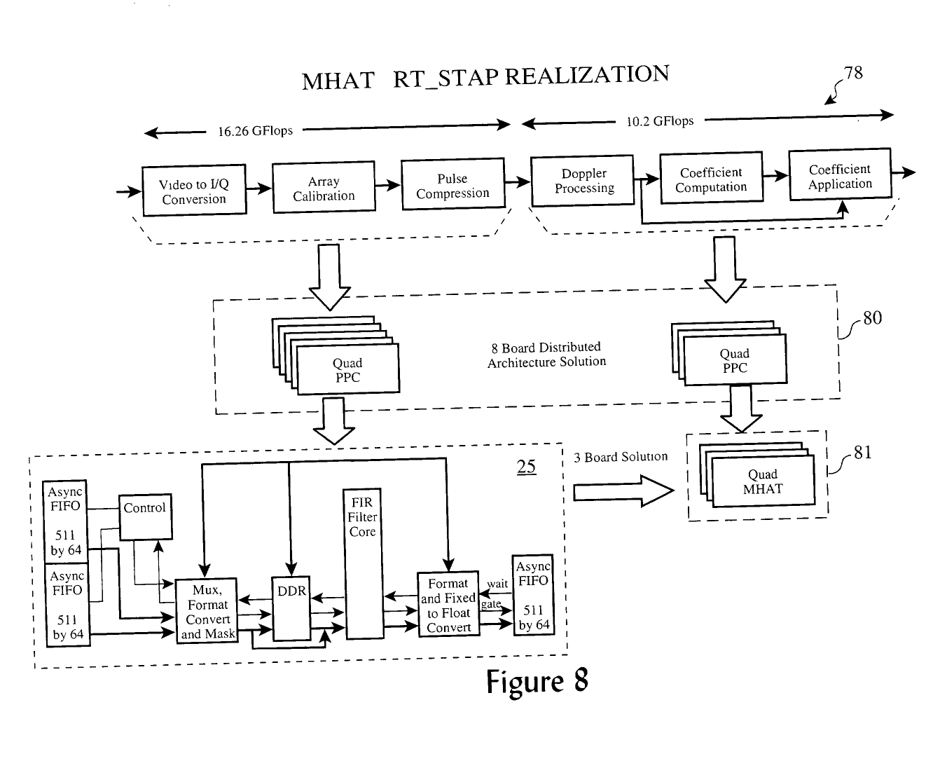

This mission profile (78) may be met using 8 quad processor modules (80) of the type available on the market and previously described, five of which are dedicated to the initial processing functions, and three of which are dedicated to the latter processing functions, as shown in FIG. 8.

However, by enhancing the QuadPPC board to include the signal processing functionality embedded into the interprocessor communication paths according to the present invention, this entire mission profile may be realized using only 3 boards or modules (81). This results in decreased failure rates by required less physical hardware, decreased cost, and reduced system characteristics (e.g. weight, dimensions, power, etc.). For airborne platforms, reductions in system characteristics such as weight, size, and power translates to greater mission range, increased aircraft performance and maneuverability.

Multiple Personality Signal Processing Resource

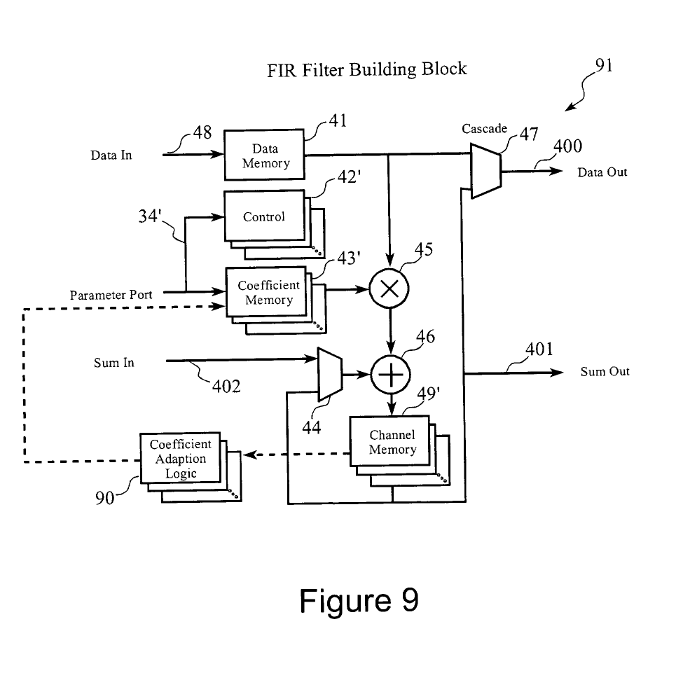

Turning to FIG. 9, another embodiment of the example FIR building block as shown in FIG. 4 is shown. However, with additional allocation of coefficient (i.e. parameter) memory (43), channel memory (49), and control logic (42) (or subdivision of existing memories), a number of coefficient memory sets (43′), channel memory sets (49′), and even control logic sets (42′) are provided. As such, prior to processing a given sample, a particular channel memory set may be selected along with a set of coefficients in a corresponding coefficient memory. For example, if the basic configuration of the signal processing block is that of an anti-aliasing (e.g. Nyquist) low pass filter (“LPF”), one coefficient set can be set for a rolloff at 2 MHz, while a second coefficient set can be set for a rolloff at 8 MHz. Then, two different channels of data can be processed through the same physical FPGA hardware by selecting the appropriate coefficient set according to which filter characteristic is to be applied to the data samples currently being processed through the resource. By adding additional control logic, such as even number samples are for the 2 MHz LPF and odd number samples are for the 8 MHz LPF. In this manner, the two channels of data can be interleaved (e.g. multiplexed into a stream of a-b-a-b-a-b, etc.), and the filter resource will process each sample accordingly. Other schemes of data organization and selection of coefficient sets can be implemented, as well, such as block processing (e.g. 1000 samples of one filter followed by 800 samples of another, etc.).

During an operation such as this wherein the coefficients for the signal processing resource are selected according to a control scheme, the channel memory sets are also correspondingly selected. Each channel memory set provides a unique storage or buffer of intermediate values from the previous filter iteration for the previous sample (or sample block), and as such, remembers the “context” of the filter from the last use of the filter with the corresponding coefficients. Contrary to traditional software practice wherein such context would have to be restored typically by many stack, memory, or pointer operations, our signal processing resource can select these coefficient sets, channel memory sets, and control sets in a single operation.

Further, for implementations wherein the control logic set is extended to include multiple control logic sets (42′), each selectable configuration may be different from each other. For example, 3 or 4 different filters can be defined, including:

Filter A: LPF at 2 MHz

Filter B: LPF at 8 MHz

Filter C: High Pass Filter (“HPF”) at 8 MHz

Filter D: Band Pass Filter (“BPF”) from 10 MHz to 50 MHz

Each of these filter sets can be viewed, then, as a “personality” to be selected for different “channels” of data for processing. The coordination and selection of control logic sets (42′) is achieved similarly to the selection of the corresponding channel memory sets (49′) and coefficient memory sets (43′).

In another variation embodiment, additional logic (90) to adapt coefficients stored in coefficient memory may be employed to realize adaptive signal processing functions, such as adaptive filters and iterative convergent numerical operations. This logic, too, may be provided in sets with the personalities of the signal processing resource, with the adaption logic sets being correspondingly selected and used for each personality.

As data which is received at the input of the signal processing block or blocks can be selectively processed by different signal processing personalities in the same hardware resource (e.g. different combinations of coefficient sets, control sets, and channel memory sets) on a sample-by-sample basis in our new system, quite a bit of flexibility in the use of the signal processing resources is afforded.

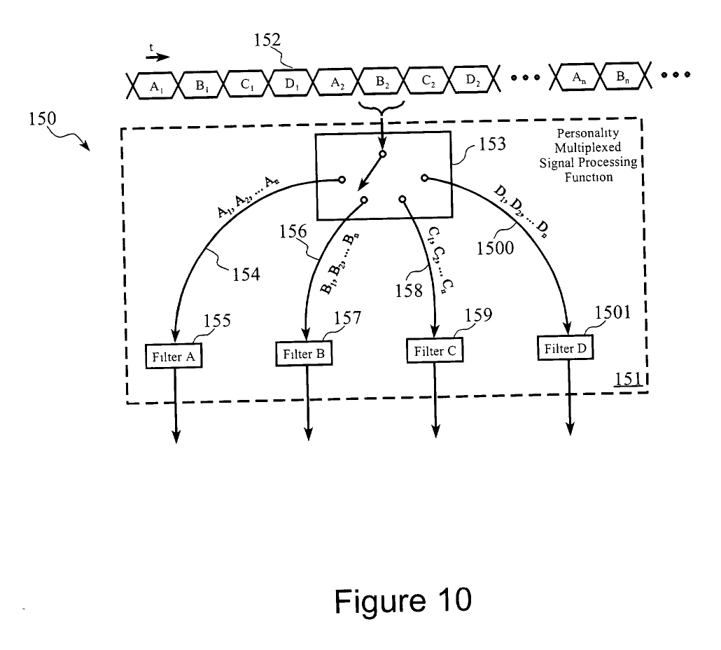

For example, consider a four-channel, time multiplexed data input stream having a format such as that shown in FIG. 10, in which data samples from four different channels A, B, C, and D are multiplexed or interleaved into a continuous data stream. In this illustration, <A₁> is a data sample from a first channel, <B₁> is a data sample from a second channel, <C₁> is a data sample from a third channel, and <D₁> is a data sample from a fourth channel. In this particular format, the four channels are “interleaved” one sample at a time, repeating the interleaving pattern every four samples in the input data stream. The data stream could be a serial or parallel data stream.

With this type of input data stream, further suppose for purposes of this example that it is desired to process channel A data using the previous example of a LPF at 2 MHz (“Filter A”), channel B data with Filter B (LPF at 8 MHz), channel C data with Filter C (HPF at 8 MHz), and channel D data with Filter D (BPF from 10 MHz to 50 MHz).

To realize such a configuration or operation of the signal processing source (151), the control logic must be configured to select one of 4 different coefficient sets and channel memory sets every input sample, synchronized and coordinated with a selected sample present or buffered from the input stream (153). For example, channel A data would be processed using control, coefficient and channel memory for Filter A, with the control logic for Filter A (155) selecting (153) Filter A's channel memory and coefficient memory only when channel A samples <A₁>, <A₁>, . . . <Aₙ> (54) are being processed. Likewise, channel B data would be processed using control, coefficient memory and channel memory for Filter B (157) when channel B samples <B₁>, <B₂>, . . . <Bₙ> (156) are being processed, and similarly for Filter C (159) for channel C data (158) and Filter D (1501) for channel D (1500) data.

This illustrates the ability of the signal processing logic (151) to multiplex over time the usage or application of coefficients, channel memories, and control logic for individual samples, thus realizing a time-multiplexed personality of the signal processing resource. As will be evident at this point to those skilled in the art, other multiplexing schemes could be accommodated with different control logic, including but not limited to framed or packeted data streams (e.g. a block of data from one channel followed by a block of data from another channel, etc.).

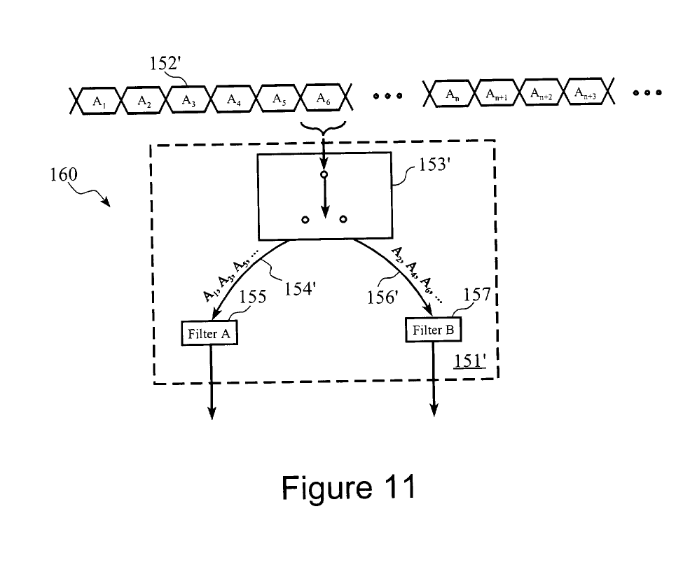

Additionally, successive data samples from the same data channel may be processed by different signal processing resource personalities to realize an undersampling function simultaneous with “parallel” signal processing of the different personalities. For example, the multiplexed personality signal processing system (160) of FIG. 11 may be realized by a variation of embodiment of the control logic (153′) in which alternating samples from the same channel data (152′) are processed by two alternating filter (or other signal processing) functions A and B (155, 157). For this example, let's assume that the original data sampling rate of channel A is 128 million samples per second (128 Msa/sec), but neither filter requires better than sample data rates of 32 Msa/sec to perform their functions with the desired accuracy. As such, the input data stream can be downsampled and “shared” between the two filters by operating Filter A on “odd” numbered samples (154′), and Filter B on “even” numbered samples (156′). FIG. 11 shows that, in this example, Filter A would the operate on samples <A₁>, <A₃>, <A₅>, . . . , and Filter B would operate on samples <A₂>, <A₄>, <A₆>, etc. This effectively downsamples the input streams to each filter to 64 Msa/sec, and processes both downsampled streams (154′, 156′) in parallel over time.

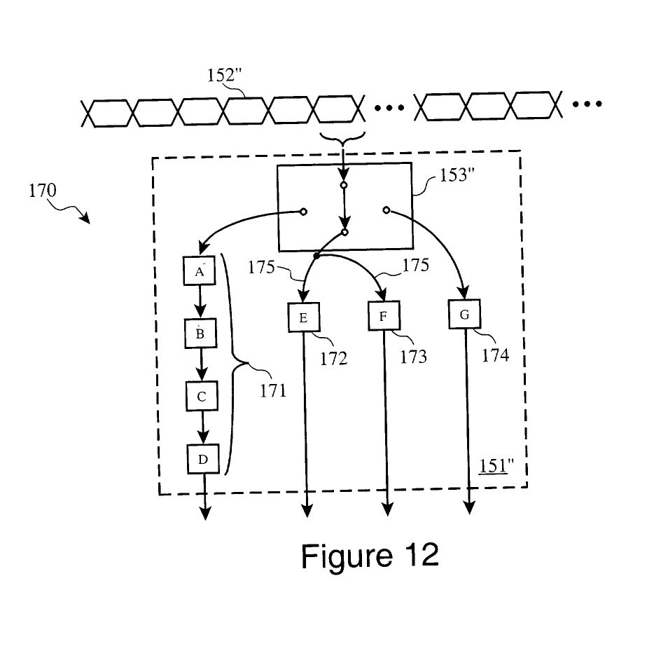

The signal processing functions, of course, do not have to be limited to filters as in the example, nor does the personality multiplexing schemes employed have to be limited to just a few signal processing personalities, highly patternistic or repetitious data input streams, etc., as the control logic may defined to implement a wider variety and much more complex multiplexing schemes which combine elements of the foregoing illustrations. For example, 4 signal processing personalities (171) could be configured to operate in series on one channel's data, while 3 other personalities (172, 173, 174) could be configured to process in parallel some portion of the input data stream, as illustrated in FIG. 12. In this personality multiplexing configuration (151″), the control logic (153″) is also configured to process a portion of the input data (175) using 2 different processing functions E (172) and F (173). In other words, the same data values input to processing function E is also input to processing F. This type of “copying” of data to multiple processing function personalities can be expanded in alternate embodiments, taking on more of a “broadcast” nature within the signal processing resource for even more complex personality multiplexing schemes.

Processing Context Saving, Loading and Restoring

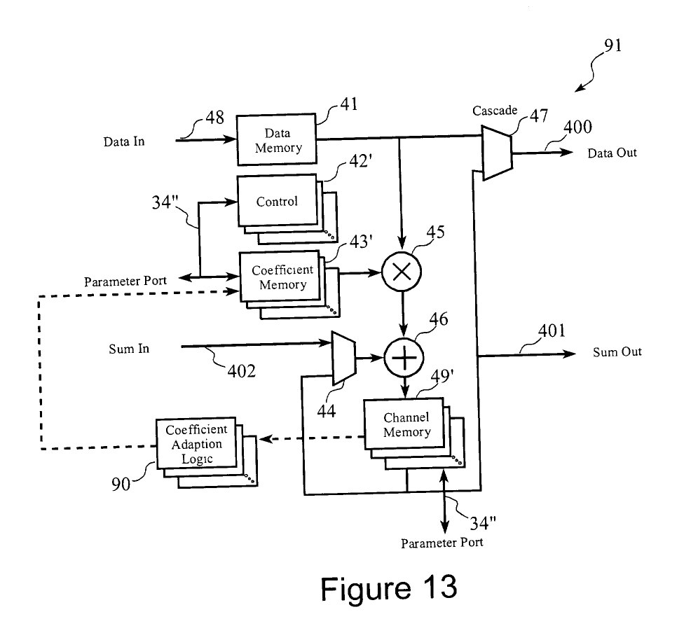

In an embodiment option for the parameter port (34″) as shown in FIG. 13, the port is adapted to load or deposit values (e.g. write by a microprocessor) into channel memory, as well. This provides several new capabilities to the multiplexing of personalities and functionalities of the signal processing resource. First, it allows the channel memory to be pre-loaded with a set of data values, such as zeroes, for initialization.

The second new capability in this embodiment arises from a further adaption of the parameter port (34″) to output the current channel memory contents to the parameter port (e.g. so that a microprocessor could “read” them and store them). This allows the intermediate values of the channel memory after processing some amount of data to be “saved” by the microprocessor, and then “restored” by writing or loading the previously saved values into channel memory so that processing of the channel data could resume where it was previously suspended.

Resumption of processing can be on the same physical resource hardware, or can be on a different resource hardware. For example, the processor could perform a certain amount of processing, suspend processing and save the channel memory contents, followed by transfering this information to a second processor where the channel memory could be loaded to resume processing on a different signal processing hardware resource. This allows division of processing functionality between different processing nodes, but preserves the ability to use the FPGA-based signal processing resources as previously described, albeit distributed among multiple FPGA's over time.

Additionally, the parameter port may be adapted to output contents of the coefficient memory, which may be especially useful for saving the context of an adaptive signal processing function in which the coefficients have been modified by the signal processing function after original loading of the coefficients by the microprocessor. This allows adaptive functions to be suspended and resumed (either on the same physical resource or another resource) as previously described related to the ability to output and save the contents of the channel memory.

Conclusion

As certain details of the example embodiments have been described and have been presented for illustration, it will be recognized by those skilled in the art that many substitutions and variations may be made from the disclosed embodiments without departing from our architecture and methods, including but not limited to alternate embodiments using other busses, communication protocols, multiplexing schemes, microprocessors, and circuit implementations. Such alternate implementations may provide improved performance, reduced costs, and/or higher reliability, to suit alternate specific requirements.

For example, the general multi-path communications arrangement may be adopted with any of a number of microprocessors, and the logic of the FPGA's may be incorporated into the circuitry of the microprocessor. Therefore, the scope of the invention should be determined by the following claims.

What is claimed is:

1. A configurable signal processing computation resource system comprising:
a data input for receiving a plurality of data samples, and having a data output;
a plurality of selectable channel memory sets, each channel memory set storing a set of computation values for said computation resource;
a plurality of selectable coefficient memory sets, each coefficient memory set storing a set of coefficients and parameters for said computation resource;
a parameter port for providing values into said coefficient memory sets; and
a control portion configured to select coefficient memory sets and channel memory sets coordinated with processing of input data samples such that signal processing function personalities are realized and applied to data samples according to a predetermined scheme.

2. The system as set forth in claim 1 further comprising a plurality of control logic sets wherein said control portion is configured to select control logic sets in association with selected channel memory sets and coefficient memory sets.

3. The system as set forth in claim 1 further comprising a plurality of selectable adaption logic sets capable of modifying the contents of one or more coefficient memory sets, and being selectable by said control portion in association with said coefficient memory sets and said channel memory sets.

4. The system as set forth in claim 1 wherein said parameter port is further adapted to load channel memory sets with values received at said parameter port.

5. The system as set forth in claim 1 wherein said parameter port is further adapted to output values from channel memory sets.

6. The system as set forth in claim 1 wherein said control portion is configured to select said signal processing function personalities according to a personality multiplexing scheme coordinated to an input data sample multiplexing scheme.

7. The system as set forth in claim 6 wherein said personality multiplexing scheme is a sample-by-sample multiplexing scheme.

8. The system as set forth in claim 6 wherein said personality multiplexing scheme is a time-division multiplexing scheme.

9. The system as set forth in claim 6 wherein said personality multiplexing scheme is a down sampling multiplexing scheme.

10. The system as set forth in claim 1 wherein said control portion is adapted to multiplex signal processing function personalities to provide parallel processing functions.

11. The system as set forth in claim 1 wherein said control portion is adapted to multiplex signal processing function personalities to provide series processing functions.

12. The system as set forth in claim 1 wherein said control portion is adapted to multiplex signal processing function personalities to provide operation of a plurality of signal processing function personalities on equivalent input data sample values.

13. The system as set forth in claim 1 wherein said configurable signal processing computation resource comprises a field programmable logic array.

14. The system as set forth in claim 1 wherein said configurable signal processing computation resource comprises a programmable logic device.

15. The system as set forth in claim 1 wherein said configurable signal processing computation resource comprises a programmable logic portion of a microprocessor.
